(19) United States
(12) Patent Application Publication
(10) Pub. No.: US 2015/0120399 A1
(43) Pub. Date: Apr. 30, 2015

(54) BUSINESS PROCESS MOTIVATION SYSTEM WITH SOCIAL MEDIA AND REWARD INTEGRATION

(71) Applicant: Maritz Holdings Inc., Fenton, MO (US)

(72) Inventors: Joseph Epplin, St. Louis, MO (US); Linda Hillermann, Eureka, MO (US)

(21) Appl. No.: 14/519,802

(22) Filed: Oct. 21, 2014

Related U.S. Application Data
(60) Provisional application No. 61/895,731, filed on Oct. 25, 2013.

(51) Int. Cl. G06Q 10/06; G06Q 50/00

(52) U.S. Cl. CPC G06Q 10/06398; G06Q 50/01
USPC 705/7.42

(57) ABSTRACT

A system includes several subsystems implemented by one or more processors executed processor executable instructions stored on a tangible, non-transitory storage device. An aggregation subsystem aggregates achievement events. An accumulation subsystem accumulates the events and optionally applies rules to the accumulated events to categorize the events. An evaluation subsystem selects and implements a reward/motivation program based on the categorized events and based on a predetermined goal. A publication subsystem applies rules to implement the selected notifications via social media. In another form, a processor executable method including processor executable instructions stored on a memory device for execution by one or more processors is described. In another form, a tangible, non-transitory computer readable media including processor executable instructions for implementing the system or method is described.

### BACKGROUND

The invention generally relates to a motivation system and in particular to a system which recognizes employee, consumer, and distribution channel behaviors which benefit or support commercial processes.

Only 45% of employees feel rewarded and recognized in meaningful ways. Furthermore, four employees out of ten are not engaged worldwide. Engagement level by region varies. While almost three-fifths (58%) of employees globally are considered in the engaged status, 42% of employees are somewhat or completely disengaged.

Employees' motivation to stay and exert extra effort falls short. While engagement levels are relatively stable, at least some employees seek new opportunities outside their organization as a result of limited career development and advancement opportunities.

Some engagement drivers have been improved in the last years, but not the ones that matter most. Across all possible engagement drivers that were examined, some improvement in Business Unit Leadership, HR Practices and Brand Alignment (fulfilling the employment contract or value proposition with employees) has been seen. However, none of these areas showed up consistently as a top driver of engagement.

Career opportunities, recognition, and organization reputation are consistently top engagement drivers. There is a need for a software platform which addresses these top engagement drivers. There is a need for a platform which allows companies to focus their efforts on improving these areas in order to have the most immediate positive impact on overall engagement. Since engagement drivers vary by business focus, the platform should have a flexibility that allows it to work within different commercial processes for different clients.

### SUMMARY

In one form, at least some embodiments of the systems and methods described herein provide an integrated platform for motivating participants (employees, consumers, distribution channels, and distributor employees).

In one form, a system includes several subsystems implemented by one or more processors executing processor executable instructions stored on a tangible, non-transitory storage device. Data defining various aspects of the system, such as rules, goals, policies and/or programs are stored in a database and/or a tangible, non-transitory storage device. An aggregation subsystem aggregates achievement events. An accumulation subsystem accumulates the events and, optionally, applies rules to the accumulated events to categorize the events. An evaluation subsystem selects and implements a reward/motivation program based on the accumulated events and based on a predetermined goal. A publication subsystem applies rules to implement selected notifications via social media.

In another form, a processor executable method including processor executable instructions stored on a memory device for execution by one or more processors is described.

In another form, a tangible, non-transitory computer readable media including processor executable instructions for implementing the system or method is described.

### BRIEF DESCRIPTION OF THE DRAWINGS

FIG. 1 is a block diagram of one embodiment of a system according to the invention, in combination with and interacting with a pre-existing IT system.

FIG. 2 is a screen shot of one embodiment of a “Blue Button” integrated into an SAP business tool for initiating the process of recognizing an employee.

FIG. 3 is a screen shot of one embodiment of an “integrated” listening device for initiating the process of recognizing an employee.

FIG. 4 is a screen shot of one embodiment of a participant experience as part of the process of recognizing the participant.

FIG. 5 is a screen shot of another embodiment of a participant experience as part of the process of recognizing the participant.

FIG. 6 is a screen shot of yet another embodiment of a participant experience as part of the process of recognizing the participant.

FIG. 7 is a diagram including a screen shot illustrating one example of an embodiment of the invention.

### DETAILED DESCRIPTION

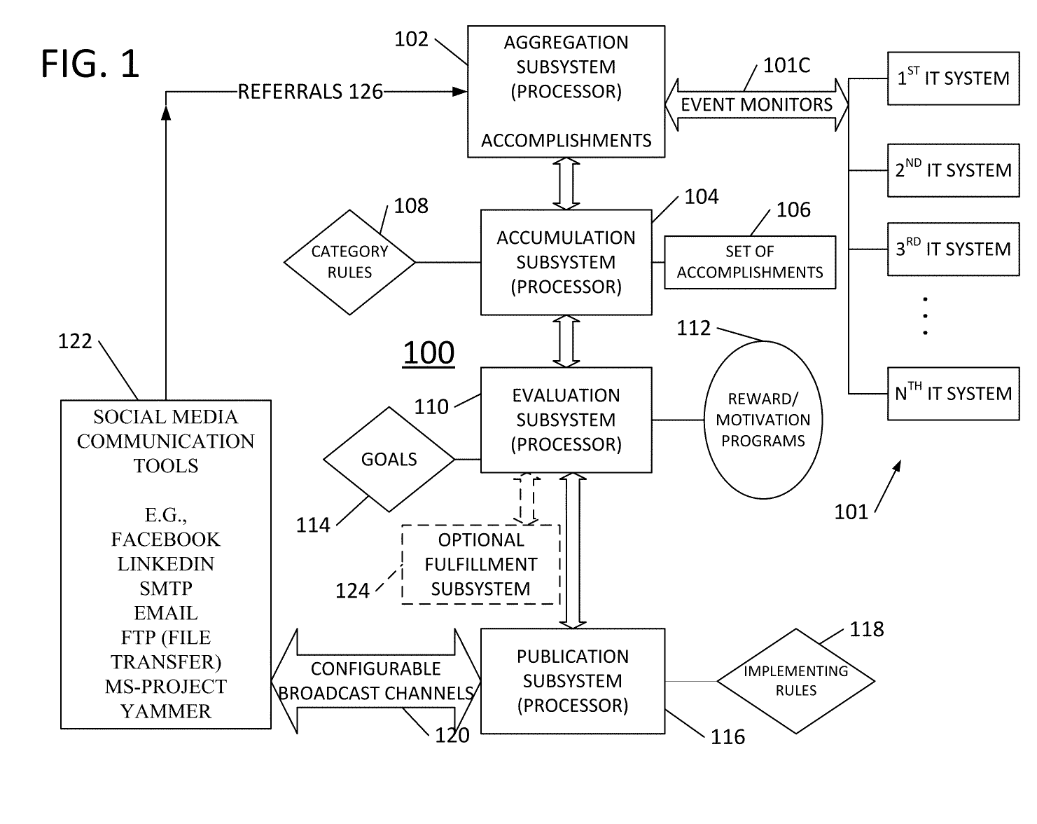

Referring to FIG. 1, in one form, a system 100 and computer method are illustrated and are for use in combination with and interacting with N pre-existing IT systems 101. In one embodiment, the system or computer method comprises one or modules of processor executable instructions stored on a tangible, non-transitory storage device. In one embodiment, the system includes one or more processors executing a plurality of subsystems (i.e., processor executable instruction subroutines, each of which is executed by one or more processors).

Via one or more event monitoring channels 101C, an aggregation subsystem 102 monitors and aggregates achievement events within the IT systems 101. The aggregated achievement events are called accomplishments. In general, an achievement event may be any event, action, happening, occasion, milestone and/or dealing and an accomplishment may be one or more related events. An accumulation subsystem 104 accumulates the accomplishments 106 from an employer network and, optionally, applies categorizing rules 108 executed by the one or more processors of the system 100 to the accomplishments 106 to categorize the accomplishments. For example, the aggregation subsystem 102 can collect emails and/or IM messages or other communications within an employer network from various employees regarding accomplishments of employees noted by the employees themselves or noted by other employees. As another example, the aggregation subsystem 102 can collect emails and/or IM messages or other communications within an people network from various people regarding accomplishments of people noted by the people themselves or noted by other people.

An evaluation subsystem 110 selects a reward/motivation program 112 executed by the one or more processors of the system 100 based on the categorized accomplishments 106 and/or based on a predetermined goal 114, such as selected by an employer or an interested party willing and able to provide the reward/motivation. A publication subsystem 116 applies implementing rules 118 executed by the one or more processors of the system 100 to implement the selected reward/motivation program 112 via configurable broadcast channels 120 connected to social media 122. Optional fulfillment subsystems 124 may be linked to and responsive to the evaluation subsystem 110 to implement one or more awards consistent with the reward/motivation programs 112 selected by the evaluation system 110.

In one form, the system 100 platform supports the association of motivation processes and principles with incumbent systems, such as Enterprise Resource, Customer Relationship Supply Chain Management and Consumer Loyalty systems. In general, it is contemplated that other associated processes and principles are supported in addition to or instead of such incumbent systems. It does this through three main components. Considering the system from a component level:
1. A Decorator Component (e.g., the aggregation subsystem 102) monitors awareness of significant achievement events that are managed by IT systems to provide a motivation solution. A significant achievement may be a single achievement, an accumulation of achievement events and/or an accumulation of achievement events where significance is predicated on the accumulation. Significant is defined as those events that have been determined by the sponsoring party to be significant in whole or in accumulation. This is achieved by utilizing IT systems' existing extension points. Widgets listen for significant achievement events and pass this information along to a comprehensive motivation program.
2. A Listener Component (e.g., the accumulation subsystem 104 and evaluation subsystem 110) accumulates, validates, and optionally categorizes large information system achievement events relevant to motivation processes by a generic, consolidated, web service interfaced, multiple client supporting application.
3. A Broadcaster Component (e.g., the publication subsystem 116, the configurable broadcast channels 120 and the social media 122) notifies all interested, approved, and relevant motivation process participants of significant accomplishment status changes through configurable broadcast channels 120 connected to social media 122 (FaceBook, LinkedIn, SMTP (eMail), FTP (file transfer), MS-Project, yammer, and other standard communication tools that are currently being used) from the Listener.

Each of these components amounts to one interaction type, which the component name reflects. Interaction will vary considerably according to the client's IT system, and can be adapted according to a client's program needs. The specific process flows implementation which define the interaction are based on commercial processes and client program needs and provide a combination of technologies (services, data aggregation, and rule driven achievement publication), motivation context, and event-driven integration with incumbent large-IT solutions, with high durability.

The system 100 platform may be integrated with enterprise systems or other than enterprise systems such as email clients, wiki sites, web sites or other consumer-based opportunities. For example, in one form, the system 100 platform is implemented by processors executing enterprise software (e.g. enterprise application software (EAS)) which are purposed-designed computer software used in the furtherance of the needs and objectives of the organization. The EAS software is intended to solve enterprise-wide problems, and/or departmental problems. For example, system integration may be implemented for EAS contexts. Alternatively or in addition, system integration may be implemented for departmental contexts. It also should be recognized that departmental goals may roll up to enterprise ones, but not all and not necessarily. As a result, integration of the system 100 platform with enterprise level software (EAS) expands the aims of EAS to improve the enterprise's productivity and efficiency by providing business logic support functionality to motivate participants. Such integration may be implemented on servers hosting the EAS to provide simultaneous services to a large number of users, typically over a computer network.

Additional components of the system 100 platform further include:
1. Configurable Receiver Channels: Use of the aggregation subsystem 102 design pattern to apply motivation processes to incumbent large information systems such as existing IT systems 101.
2. Accomplishments Engine: The accumulation, validation, and aggregation of information system events from various sizes of sourcing systems relevant to motivation processes by a consolidated, web service interfaced, multiple client supporting accumulation subsystem 104 and an evaluation subsystem 110.
3. Configurable Broadcast Channels: The notification of significant accomplishment status changes to all interested, approved, and relevant motivation process participants through configurable broadcast channels 120 of the publication system 116 (FaceBook, LinkedIn, SMTP (eMail), FTP (file transfer), MS-Project, yammer, . . . ) from a consolidated, web service interfaced, multiple client supporting application.

The system 100 platform may include APIs and/or an optional link to one or more fulfillment subsystem.

The following illustrates some examples.

Examples of Achievement Events and Operation of the Aggregation Subsystem 102

Achievement events range across all business processes for which clients my desire a motivational component. Note all of these will then be fed to a rules engine that is applied in the accumulation subsystem in next step. Some examples of achievement events which may be monitored by the aggregation subsystem 102 are:
1. Interaction center number of calls handled (the aggregation subsystem 102 aggregates the calls in light of individual and/or department goals)
2. Interaction center number of closed issues (the aggregation subsystem 102 aggregates the closed issues in light of individual and/or department goals)
3. Sales target achieved (the aggregation subsystem 102 is registered with a Sales Force Automation System e.g. salesforce.com to observe target achievement and aggregate events. Alternatively, a Sales Force Automation System e.g. salesforce.com sends a flat file with sales achievement information to the aggregation subsystem 102.)
4. Sales target progress toward goal (similar to #3)
5. Lead accurately recorded (When the nightly data validation check for businesses entered as leads into a Sales Force Automation system is run, the number of new leads entered by each rep that validates cleanly is recorded to the aggregation subsystem 102 and aggregated into accomplishments 106. Then, optional category rules 108 that reflect the value of a number of accurate entries and that credit the reps are applied to the accomplishments 106 by the accumulation subsystem 104.)
6. Opportunity accurately evaluated (similar to #5)
7. Billable time promptly recorded (the aggregation subsystem 102 is registered with an Enterprise Resource Planning (ERP) system, e.g. SAP, to observe target achievements (e.g., time entered) to aggregate accomplishments. Alternatively, an Enterprise Resource Planning system, e.g. SAP, sends a flat file with time entry information to the aggregation subsystem 102.)
8. Billable time threshold reached (similar to #7)
9. The number of referrals 126 generated by an individual (e.g., distributor and/or distributor employee) through social media 122 is captured on an event-driven basis through integration with the social media (e.g., Twitter integration). The referrals 126 are communicated to the aggregation subsystem 102. Optional category rules 108 or goals 114 that reflect the value of number of referrals 126 are applied and credit the distributor and/or distributor employee.
10. Distributor sales target achieved—Goals 114 established by a manufacturing client through previously configured reward/motivation program 112 are aggregated by the aggregation subsystem 102, accumulated and optionally categorized by the accumulation subsystem 104, and identified by the evaluation subsystem 110.

The aggregation subsystem 102 monitors the various IT systems 101 for one or more of the above noted achievement events, or other events, and aggregates the events into accomplishments 106. The events may be aggregated according to each individual involved, according to each individual's involvement, according to project, by time, and/or according to other factors.

Examples of Optional Category Rules 108 Applied by the Accumulation Subsystem 104
1. Number of employees for one supervisor recognized is fed to a function that maps it into a value.
2. Contributions by an employee to a corporate site such as a wiki/SharePoint/document/Yammer site are fed to a function that maps it into a value.
3. A length of a Period of Time (e.g., Number of hours) of project elements tracking at or before schedule completion by an employee are mapped to a value.

Examples of Categories of Events Defined by Optional Category Rules 108:
1. Customer Relationship Management
2. Supply Chain Management
3. Product Lifecycle Management
4. Supplier Relationship Management
5. Global Trade Services
6. Enterprise Resource Planning (ERP)
7. Service and Asset Management

Each category may have one or more subcategories as defined by the category rules 108.

Examples of how the Evaluation Subsystem 110 Operates

The evaluation subsystem 110 is programmed to invoke a rule when a criterion for accomplishment is reached. The operation of the evaluation subsystem 110 is optional because is may not be utilized for each accomplishment processed. Thus, whether or not it is invoked is optional. When invoked, the context (who, what, when, at which business and department) is provided to a software module that queries a database for the value of that accomplishment for the individual and their department. A value in an appropriate currency (reputation points, merchandise points, virtual points, legal tender, in kind, etc.) is credited to the individual and/or department.

Examples of Implementing Rules 118 Executed by the Publication Subsystem 116

Each customer can express their policies (stored in a database) defining the notification(s) to social media and messaging avenues (e.g., email, text, instant messaging, social media) for when the participants which they are sponsoring achieve a specified type or list of types of accomplishments. The implementing rules 118 (e.g., publication rules) are used by the publication subsystem 116 to express those policies and provide rewards and motivation to the participants. For example, when the sales staff sells more than $100K of a product, their employer may allow, with their agreement, for that achievement to be pushed to LinkedIn. As another example, when an employee achieves a particular goal, their employer may allow, with the employee's agreement, for the achievement to be posted on the employee's FaceBook website.

Examples of APIs for Use in Interfacing with Social Media 122
1. JSON
2. XML
3. jQuery
4. REST
5. mule
6. jigsaw

One strength and distinctiveness of the system when integrated with an incumbent enterprise system is that it pulls together three simple interactions into one powerful platform: the association of motivation processes and principles with incumbent Enterprise Resource, Customer Relationship, Supply Chain Management, and Consumer Loyalty systems and the like, by event-driven services, data aggregation, and rule driven achievement publication. The flow will vary considerably per partner IT system, and will necessarily be adapted according to a client's program needs.

Understanding the Motivation Gap: How the System 100 Platform Fills the Gap

The Maritz Institute connects a network of leading scientists, academics and business professionals in a collaborative approach focused on science-based business practice innovation. Insights into people, based on human science discoveries, have delivered the realization that business must change to more fully unleash the power of people. An early outcome of this collaboration has been the identification of three, core “people principles” based on current scientific research:
People are driven by multiple motivators or biological drives, including the drives to Acquire, Bond, Create and Defend—a point of view based on the ground-breaking four-drive theory of human behavior developed by Paul Lawrence and Nitin Nohria at Harvard Business School.
People are emotional and rational. Reason and emotional brain processes are so closely intertwined that emotions play a critical role in virtually all conscious choice-making. This helps explain why people will behave in seemingly irrational ways based on perceptions of fairness and trust, or to conform to social norms.
People are individual and social. The concept of identity must consider people both as individuals and as members of their social groups. And, the ability of individuals to shape the behavior of others—whether other individuals, groups or entire organizations through social influence and emotional contagion—is more powerful than previously understood.

The system 100 supports these People Principles as the system 100 allows users to be the creator of their own reputation, enhancing their status by acquiring skills and knowledge and broadcasting their accomplishments publicly within ones social circle only to be self-obligated to defend their reputation through continuous accomplishments and self-improvement that supports their growth and benefits the organization as well as provides social influence and emotional contagion for the entity at large.

Neuroscience can be more easily translated into 5 key questions that a participant should be able to answer in order for a performance improvement solution to be successful.

What do you want people to do? and Why is it important? —These questions reinforce and are tied to the importance of communication and how critical it is to help people understand the goals 114 and strategies and align them with their own intrinsic goals. The system 100 facilitates clients to define goals 114 and encourages participants to have focus, and get on board with the client.

How do you want people to do it? —Because behavior is shaped by both emotional and rationale thought, the system 100 drives clients to ensure that participants have the tools and knowledge necessary to achieve the goals 114. This allows participants to perceive the client's request to be fair and achievable through communications and earning design, and at times training, technology or administration tools.

How do you provide Measurement and Feedback? —Because it is hard to learn new behaviors and focus, repetition and feedback are critical to wiring the brain. The measurement and feedback deliverables (e.g., reporting, event/accomplishment driven email, announcements provided to social media 122 via the configurable broadcast channels 120, or other communications), provided by the system 100 are a solution element.

What is in it for people? —Because the consequences drive behavior, in neuroscience the reward/motivation programs 112 are a collection of brain structures which attempt to regulate and control behavior by inducing pleasurable effects. The system 100 platform offers acknowledgements via the publication subsystem 116 and rewards, such as via an optional fulfillment subsystem 124, that ensure a meaningful, memorable and motivating consequence for all participants. The system 100 encourages participants to set goals consistent with the specified goals 114 and allows social reinforcement for greatest effectiveness.

Some additional benefits of the system 100 platform, method and software implementation of embodiments wherein participants are employees and the client is their employer include:
Clients' employees are more engaged in their work environment.
Clients' adoption and usage increase making the overall enterprise software more valuable and resulting in increased customer satisfaction
Clients recognize financial gain from the increased use and adoption of the system 100, resulting in contract renewals.
More depth is added to portfolio services, gaining incremental revenue from existing customers, resulting in product expansion and increased revenue.

Similarly, the ERP processes can be defined to bring efficiency from a financial, operational and engagement perspective. For example, this may show up in a product or service in various ways:
Talent Management—e.g., recognizing an HR recruiter for providing a minimum (e.g., 3 or more) qualified candidates to interview for an opening.
Travel Management—e.g., recognizing an employee for using a lowest cost option.
Financial Supply Chain Management—e.g., recognizing someone for submitting and implementing a cost savings idea.
Document Management—e.g., recognizing a team for favorable results from documentation retention strategy audit.
Operational Sourcing—e.g., recognizing an employee for satisfying quotas on Purchase Order to maximize rebate potential.
Purchase Order Management—e.g., recognizing an employee for on time deliveries, per established SLA's.
Invoice Management—e.g., recognizing a team for zero price or quantity variances over a set time period.
Quality Management—e.g., recognizing a team for zero customer returns as a result of poor quality over a set time period.
Inventory and Warehouse Management—e.g., recognizing a team for zero receipt variance to purchase order quantities over set time period.
Project and Portfolio Management—e.g., recognizing an employee or team for staying on budget and or meeting/beating deadlines.

Examples of One Specific Implementation

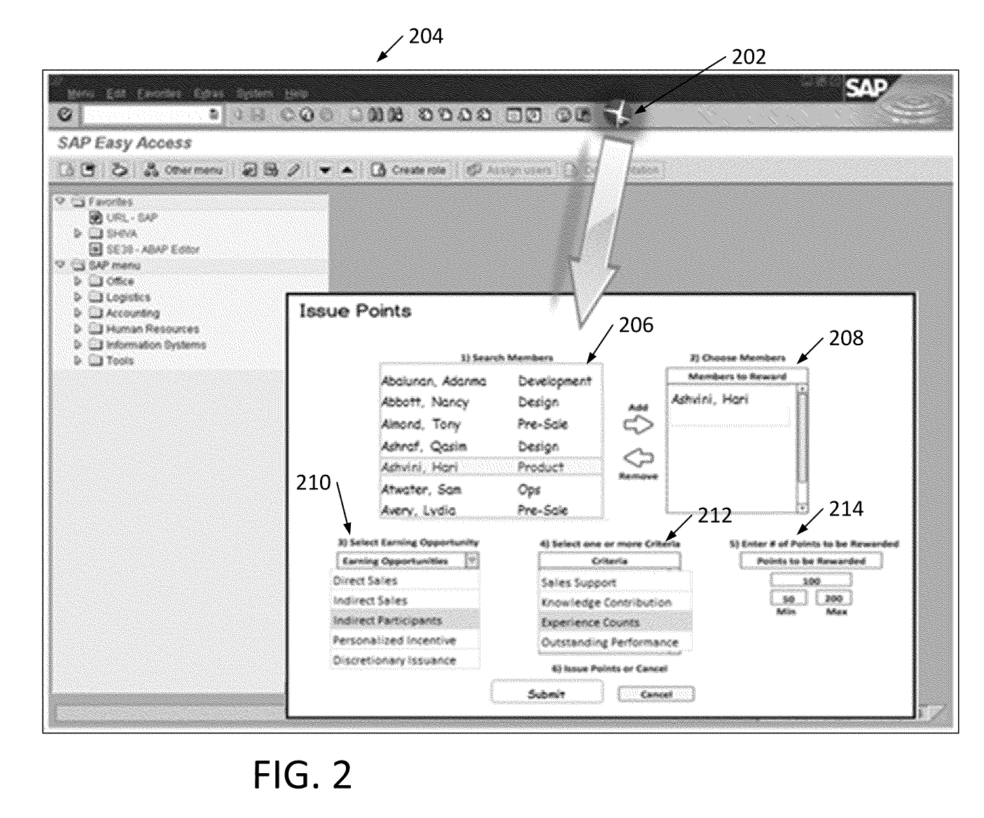

FIG. 2 is a screen shot of one embodiment of a “Blue Button” 202 integrated into an SAP business tool 204 for initiating the process of recognizing an employee. “Blue Button” is an icon based single interaction invocation of the motivation capabilities.

Supervisors click the “Blue Button” 202 to initiate an acknowledgement of behavior exhibited in accordance with the pre-established policy. In this example, the supervisor is able to issue points to employees. The “Blue Button” 202 executes a subroutine which presents to a supervisor a list of employees 206, identified as list of members of the program. The list can be searched by the supervisor to locate a particular employee. Supervisors select the particular employee(s). The name of each selected particular employee appears in window 208 as being chosen for a reward. Window 210 includes a pull down menu with earnings opportunities. Window 212 requires the supervisor to identify a criterion for the reward to be provided and in window 214 the supervisor assigns points within the recommended range, before submitting for implementation.

The “Blue Button” may be integrated into other business tools, such as Outlook and SharePoint allowing for a consistent methodology for addressing behavior modification within an organization. For the employees, they are recognized for their accomplishments in a consistent way and, importantly to them, all the points earned are in one basket, giving them the opportunity to redeem for a larger value reward, making the experience more meaningful, memorable and motivating.

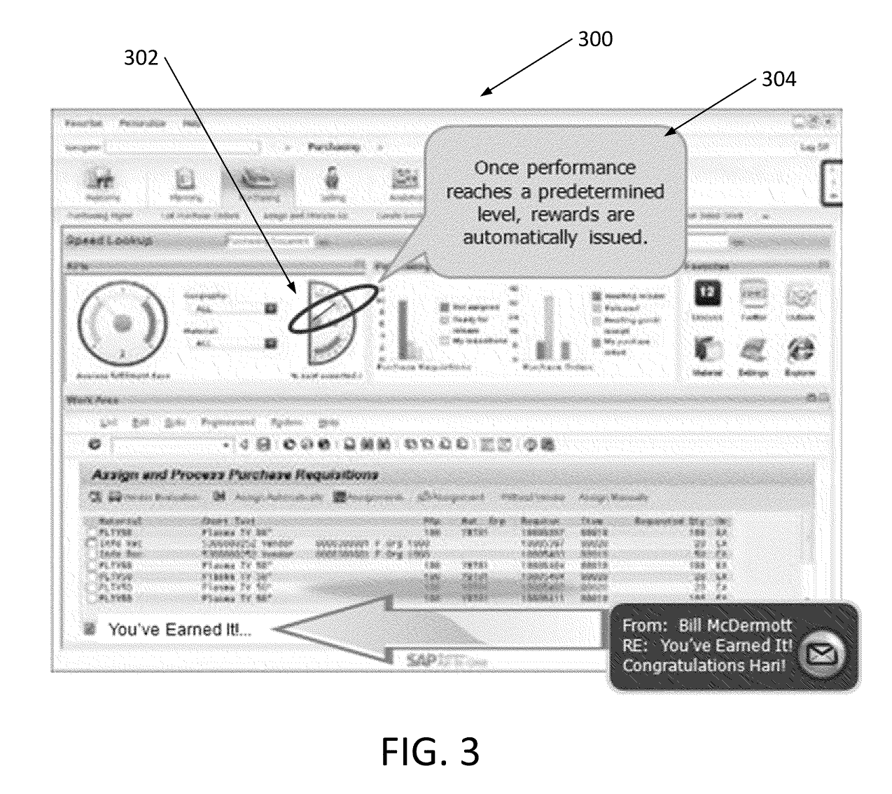

FIG. 3 is a screen shot 300 of one embodiment of an “integrated” listening device for initiating the process of recognizing an employee. In this example, part of the aggregation subsystem monitors participant performance as illustrated at 302. Once the performance of the participant is maintained at a certain level over time, a reward is issued automatically as indicated by the balloon 304. In one form, a smaller reward initially to anchor the participant's expectations may be implemented. Thereafter, a slightly larger reward for maintenance to surprise and delight the participant is provided.

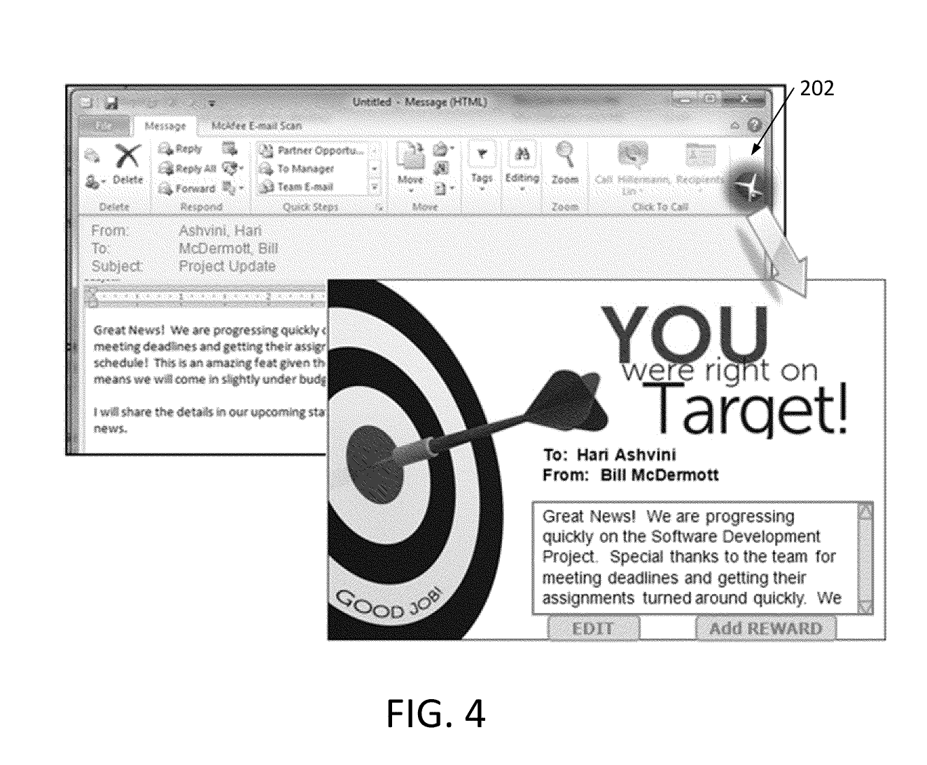

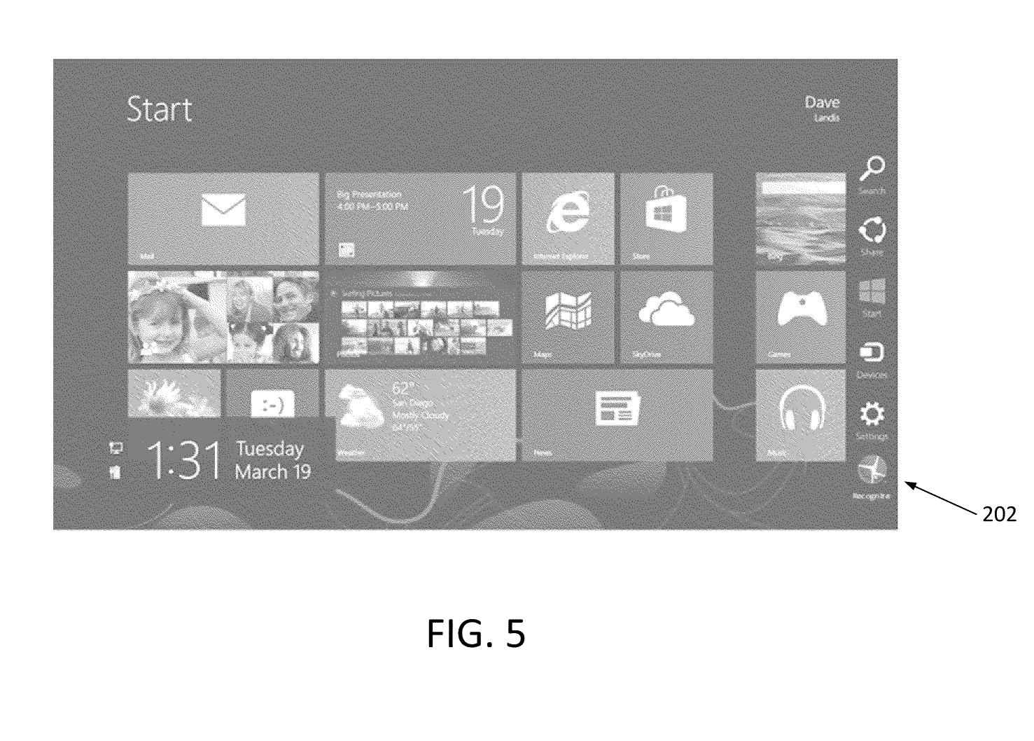

FIGS. 4 and 5 are screen shots of optional embodiments of a participant experience as part of the process of recognizing the participant. In the FIG. 4 example, a “Blue Button” 202 in Outlook automatically uses the content of the email, including recipients to create an acknowledgement of an accomplishment. The optional “Blue Button” 202 makes it easy to recognize and/or reward behavior or a great performance, manually or automatically. In this example, the email is aggregated by the aggregation subsystem 102, the email is accumulated by the accumulation subsystem 104 and the “Blue Button” 202 is implemented by the evaluation subsystem 110. The publication subsystem 116 presents the “you were right on target” notice to Bill McDermott for editing and/or adding a reward. FIG. 5 is another example of an implementation of “Blue Button” 202 using Microsoft® 8 OS and their “Charms” approach. In FIG. 5, the “Blue Button” 202 may be selected to recognize and/or reward a person in response to a user noticing an accomplishment of the person which should be recognized and/or rewarded. The “Blue Button” 202 is optional; this type of function may be implemented in addition to or instead of some or all of the event monitoring 101C.

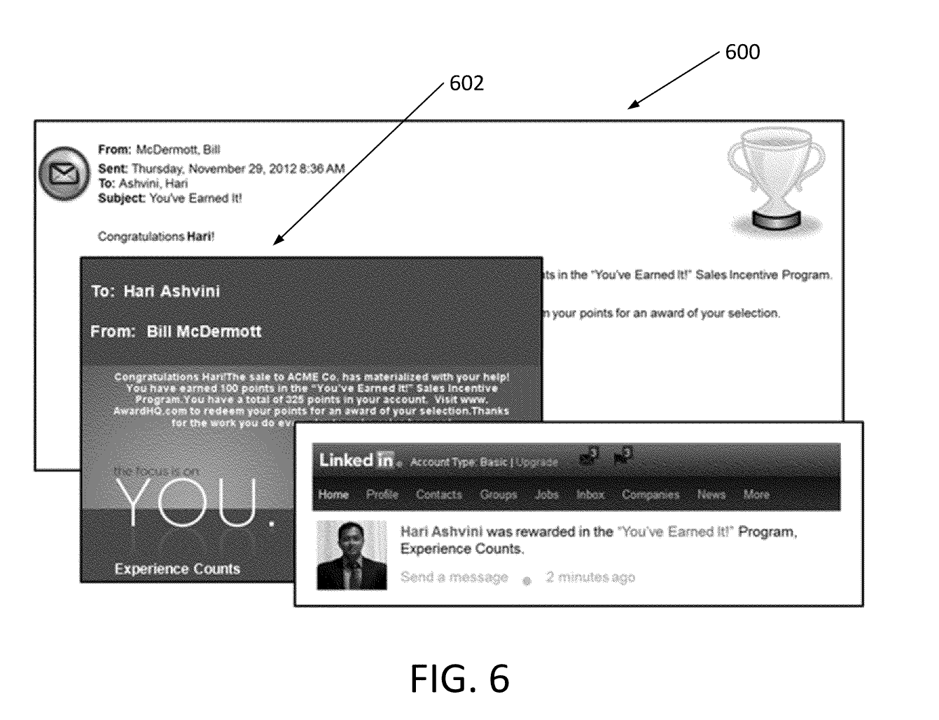

FIG. 6 is a screen shot 600 of another embodiment of a participant experience as part of the process of recognizing the participant. In this example, the participant automatically receives an email 602 (or other notification such as an e-card) acknowledging the accomplishment as well as it being posted to social media, Facebook, LinkedIn or Twitter, implemented by the publication subsystem 116.

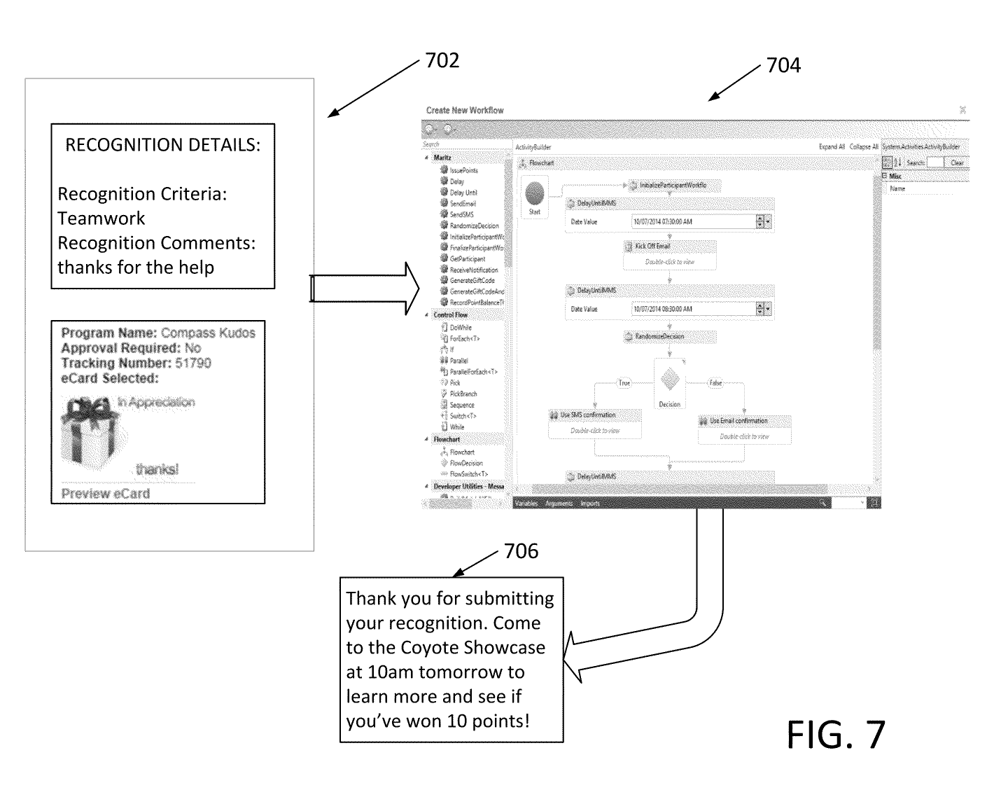

FIG. 7 is a diagram including a screen shot illustrating one example of an embodiment of the invention. Reference character 702 illustrates an exemplary window provided to a participant initiating a recognition via a website. The recognition is submitted via the website. The submission event invokes a rule set 704 of processor executable instructions executed a server/subsystem connected to the website. The rule set 704 communicates with participants associated with the website. For example, participants can have a log-in to the website in general, or participants may be part of a specific promotion and/or campaign. The rule set 704, illustrated as a screen shot entitled “Create New Workflow”, can use an email, mobile number, or other contact vehicle which is registered to the participants. For example, the rule set 704 can send an SMS text message 706 to the participant initiating the recognition thanking the participant for submitting the recognition. The participant initiating the recognition could also receive an award for their behavior, if desired.

In one form, the invention can be implemented as a processor executable method including processor executable instructions stored on a memory device for execution by one or more processors. The method comprises instructions stored on a tangible memory device, comprising:
instructions executed by a processor for aggregating achievement events;
instructions executed by a processor for accumulating the achievement events into accomplishments and applying rules to the accomplishments to categorize the accomplishments;
instructions executed by a processor for selecting and implementing a reward/motivation program based on the categorized accomplishments and based on a predetermined goal; and
instructions executed by a processor for applying rules to implement selected notifications via social media.

In one form of the method, the aggregating instructions interface with at least one IT system and monitor one or more of the following achievement events within the monitored IT system: event, action, happening, occasion, milestone and/or dealing; and wherein one or more of the monitored events are aggregated as an accomplishment according to each individual involved.

In one form of the method, the accumulating instructions apply rules that reflect a value of a number of accurate entries applied to the accomplishments of an employee and that credit the employee.

In one form of the method, the accumulating instructions apply at least one of the following rules:
(a) mapping a number of recognized employees for a supervisor to a value;
(b) mapping contributions of an employee to a corporate site;
(c) mapping a period of time of early completion by an employee of a project element to a value; and
(d) mapping a number of referrals by an individual through social media.

In one form of the method, the evaluating instructions invoke a rule when a criterion for a particular accomplishment is reached, wherein a context including at least one of who, what, when, at which business, and at which department is provided to a module that queries a database for the value of the particular accomplishment.

In one form of the method, policy instructions stored in a database regarding a notification to social media define messaging avenues for participant accomplishments and the rules implement policies and provide rewards and motivation to the participants.

In one form, the invention can be implemented as a tangible, non-transitory computer readable media (CRM) including processor executable instructions for:
aggregating achievement events;
accumulating the achievement events into accomplishments and applying rules to the accomplishments to categorize the accomplishments;
selecting and implementing a reward/motivation program based on the categorized accomplishments and based on a predetermined goal; and
applying rules to implement selected notifications via social media.

In one form of the CRM, the aggregating instructions interface with at least one IT system and monitor one or more of the following achievement events within the monitored IT system: event, action, happening, occasion, milestone and/or dealing; and wherein one or more of the monitored events are aggregated as an accomplishment according to each individual involved.

In one form of the CRM, the accumulating instructions apply rules that reflect a value of a number of accurate entries applied to the accomplishments of an employee and that credit the employee.

In one form of the CRM, the accumulating instructions apply at least one of the following rules:
(a) mapping a number of recognized employees for a supervisor to a value;
(b) mapping contributions of an employee to a corporate site;
(c) mapping a period of time of early completion by an employee of a project element to a value; and
(d) mapping a number of referrals by an individual through social media.

In one form of the CRM, the evaluating instructions invoke a rule when a criterion for a particular accomplishment is reached, wherein a context including at least one of who, what, when, at which business, and at which department is provided to a module that queries a database for the value of the particular accomplishment.

In one form of the CRM, policy instructions stored in a database regarding a notification to social media define messaging avenues for participant accomplishments and the rules implement policies and provide rewards and motivation to the participants.

The Abstract and summary are provided to help the reader quickly ascertain the nature of the technical disclosure. They are submitted with the understanding that they will not be used to interpret or limit the scope or meaning of the claims. The summary is provided to introduce a selection of concepts in simplified form that are further described in the Detailed Description. The summary is not intended to identify key features or essential features of the claimed subject matter, nor is it intended to be used as an aid in determining the claimed subject matter.

For purposes of illustration, programs and other executable program components, such as the operating system, are illustrated herein as discrete blocks. It is recognized, however, that such programs and components reside at various times in different storage components of a computing device, and are executed by a data processor(s) of the device.

Although described in connection with an exemplary computing system environment, embodiments of the aspects of the invention are operational with numerous other general purpose or special purpose computing system environments or configurations. The computing system environment is not intended to suggest any limitation as to the scope of use or functionality of any aspect of the invention. Moreover, the computing system environment should not be interpreted as having any dependency or requirement relating to any one or combination of components illustrated in the exemplary operating environment. Examples of well-known computing systems, environments, and/or configurations that may be suitable for use with aspects of the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the aspects of the invention may be described in the general context of data and/or processor-executable instructions, such as program modules, stored one or more tangible, non-transitory storage media and executed by one or more processors or other devices. Generally, program modules include, but are not limited to, routines, programs, objects, components, and data structures that perform particular tasks or implement particular abstract data types. Aspects of the invention may also be practiced in distributed computing environments where tasks are performed by remote processing devices that are linked through a communications network. In a distributed computing environment, program modules may be located in both local and remote storage media including memory storage devices.

In operation, processors, computers and/or servers may execute the processor-executable instructions (e.g., software, firmware, and/or hardware) such as those illustrated herein to implement aspects of the invention.

Embodiments of the aspects of the invention may be implemented with processor-executable instructions. The processor-executable instructions may be organized into one or more processor-executable components or modules on a tangible processor readable storage medium. Aspects of the invention may be implemented with any number and organization of such components or modules. For example, aspects of the invention are not limited to the specific processor-executable instructions or the specific components or modules illustrated in the figures and described herein. Other embodiments of the aspects of the invention may include different processor-executable instructions or components having more or less functionality than illustrated and described herein.

The order of execution or performance of the operations in embodiments of the aspects of the invention illustrated and described herein is not essential, unless otherwise specified. That is, the operations may be performed in any order, unless otherwise specified, and embodiments of the aspects of the invention may include additional or fewer operations than those disclosed herein. For example, it is contemplated that executing or performing a particular operation before, contemporaneously with, or after another operation is within the scope of aspects of the invention.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

In view of the above, it will be seen that several advantages of the aspects of the invention are achieved and other advantageous results attained.

Not all of the depicted components illustrated or described may be required. In addition, some implementations and embodiments may include additional components. Variations in the arrangement and type of the components may be made without departing from the spirit or scope of the claims as set forth herein. Additional, different or fewer components may be provided and components may be combined. Alternatively or in addition, a component may be implemented by several components.

The above description illustrates the aspects of the invention by way of example and not by way of limitation. This description enables one skilled in the art to make and use the aspects of the invention, and describes several embodiments, adaptations, variations, alternatives and uses of the aspects of the invention, including what is presently believed to be the best mode of carrying out the aspects of the invention. Additionally, it is to be understood that the aspects of the invention is not limited in its application to the details of construction and the arrangement of components set forth in the following description or illustrated in the drawings. The aspects of the invention are capable of other embodiments and of being practiced or carried out in various ways. Also, it will be understood that the phraseology and terminology used herein is for the purpose of description and should not be regarded as limiting.

Having described aspects of the invention in detail, it will be apparent that modifications and variations are configurable without departing from the scope of aspects of the invention as defined in the appended claims. It is contemplated that various changes could be made in the above constructions, products, and methods without departing from the scope of aspects of the invention. In the preceding specification, various preferred embodiments have been described with reference to the accompanying drawings. It will, however, be evident that various modifications and changes may be made thereto, and additional embodiments may be implemented, without departing from the broader scope of the aspects of the invention as set forth in the claims that follow. The specification and drawings are accordingly to be regarded in an illustrative rather than restrictive sense.

What is claimed is:

1. A system including one or more processors executing:
An aggregation subsystem for aggregating achievement events;
An accumulation subsystem for accumulating the achievement events into accomplishments and applying rules to the accomplishments to categorize the accomplishments;
An evaluation subsystem for selecting and implementing a reward/motivation program based on the categorized accomplishments and based on a predetermined goal; and
A publication subsystem for applying rules to implement selected notifications via social media.

2. The system of claim 1 wherein the aggregation subsystem interfaces with at least one IT system and monitors one or more of the following achievement events within the monitored IT system: event, action, happening, occasion, milestone and/or dealing; and wherein one or more of the monitored events are aggregated as an accomplishment according to each individual involved.

3. The system of claim 1 wherein the accumulation subsystem applies rules that reflect a value of a number of accurate entries applied to accomplishments of an employee and that credit the employee.

4. The system of claim 3 wherein the accumulation subsystem applies at least one of the following rules:
(a) mapping a number of recognized employees for a supervisor to a value;
(b) mapping contributions of an employee to a corporate site;
(c) mapping a period of time of early completion by an employee of a project element to a value; and
(d) mapping a number of referrals by an individual through social media.

5. The system of claim 1 wherein the evaluation subsystem invokes a rule when a criterion for a particular accomplishment is reached, wherein a context including at least one of who, what, when, at which business and at which department is provided to a module that queries a database for the value of the particular accomplishment.

6. The system of claim 1 further comprising a policy stored in a database regarding a notification to social media and defining messaging avenues for participant accomplishments and wherein the publication subsystem executes implementing rules to implement those policies and provide rewards and motivation to the participants.

7. A processor executable method including processor executable instructions stored on a memory device for execution by one or more processors, said method comprising instructions stored on a tangible memory device, said instructions comprising:
aggregating achievement events;
accumulating the achievement events into accomplishments and applying rules to the accomplishments to categorize the accomplishments;
selecting and implementing a reward/motivation program based on the categorized accomplishments and based on a predetermined goal; and
applying rules to implement selected notifications via social media.

8. The method of claim 7 wherein the aggregating instructions interface with at least one IT system and monitor one or more of the following achievement events within the monitored IT system: event, action, happening, occasion, milestone and/or dealing; and wherein one or more of the monitored events are aggregated as an accomplishment according to each individual involved.

9. The method of claim 7 wherein the accumulating instructions apply rules that reflect a value of a number of accurate entries applied to the accomplishments of an employee and that credit the employee.

10. The method of claim 9 wherein the accumulating instructions apply at least one of the following rules:
(a) mapping a number of recognized employees for a supervisor to a value;
(b) mapping contributions of an employee to a corporate site;
(c) mapping a period of time of early completion by an employee of a project element to a value; and
(d) mapping a number of referrals by an individual through social media.

11. The method of claim 7 wherein the evaluating instructions invoke a rule when a criterion for a particular accomplishment is reached, wherein a context including at least one of who, what, when, at which business, and at which department is provided to a module that queries a database for the value of the particular accomplishment.

12. The method of claim 7 wherein further comprising policy instructions stored in a database regarding a notification to social media and defining messaging avenues for participant accomplishments and wherein the rules implement policies and provide rewards and motivation to the participants.

13. A tangible, non-transitory computer readable media including processor executable instructions for:
aggregating achievement events;
accumulating the achievement events into accomplishments and applying rules to the accomplishments to categorize the accomplishments;
selecting and implementing a reward/motivation program based on the categorized accomplishments and based on a predetermined goal; and
applying rules to implement selected notifications via social media.

14. The media of claim 13 wherein the aggregating instructions interface with at least one IT system and monitor one or more of the following achievement events within the monitored IT system: event, action, happening, occasion, milestone and/or dealing; and wherein one or more of the monitored events are aggregated as an accomplishment according to each individual involved.

15. The media of claim 13 wherein the accumulating instructions apply rules that reflect a value of a number of accurate entries applied to the accomplishments of an employee and that credit the employee.

16. The media of claim 15 wherein the accumulating instructions apply at least one of the following rules:
(a) mapping a number of recognized employees for a supervisor to a value;
(b) mapping contributions of an employee to a corporate site;
(c) mapping a period of time of early completion by an employee of a project element to a value; and
(d) mapping a number of referrals by an individual through social media.

17. The media of claim 13 wherein the evaluating instructions invoke a rule when a criterion for a particular accomplishment is reached, wherein a context including at least one of who, what, when, at which business, and at which department is provided to a module that queries a database for the value of the particular accomplishment.

18. The media of claim 13 wherein further comprising policy instructions stored in a database regarding a notification to social media and defining messaging avenues for participant accomplishments and wherein the rules implement policies and provide rewards and motivation to the participants.
